(19) United States
(12) Patent Application Publication
(10) Pub. No.: US 2002/0032590 A1
(43) Pub. Date: Mar. 14, 2002

(54) E-market architecture for supporting multiple roles and reconfigurable business porcesses

(75) Inventors: Rangachari Anand, Teaneck, NJ (US); Mitchell A. Cohen, Yorktown Heights, NY (US); Vibby Gottemukkala, Ossining, NY (US); Anant Jhingran, San Jose, CA (US); Manoj Kumar, Yorktown Heights, NY (US); Rakesh Mohan, Stamford, CT (US); Carlos Perez, Germantown, MD (US); Jakka Sairamesh, New York, NY (US); Karthikeyan Seetharaman, Peekskill, NY (US)

Correspondence Address: Robert P. Tassinari, Jr., Intellectual Property Law Dept., IBM Corporation, P.O. Box 218, Yorktown Heights, NY, 10598, US

(73) Assignee: International Business Machines Corporation, Armonk, NY (US)

(21) Appl. No.: 09/818,719

(22) Filed: Mar. 27, 2001

Related U.S. Application Data
(60) Provisional application No. 60/192,687, filed on Mar. 28, 2000.

(51) Int. Cl. G06F 17/60

(52) U.S. Cl. 705/7

(57) ABSTRACT

A method for allowing flexible creation and alteration of business processes within a commerce system includes using state machines to describe the actions that can be taken by particular roles at particular points in a process. The state machines are used by a commerce system to enforce validity of user actions, to track the execution of actions within an instance of the business process, to provide the user interface with a list of actions available to a user working on an instance of the business process, to provide coordination between state machines, and to allow different organizations to have varied business processes.

### REFERENCE TO PROVISIONAL APPLICATION

This application claims the benefit of the filing date of corresponding U.S. Provisional Patent Application No. 60/192,687, entitled “An E-Market Architecture for Supporting Multiple Roles and Reconfigurable Business Processes”, filed Mar. 28, 2000.

### FIELD OF THE INVENTION

The invention relates to a system and method for supporting business processes in commerce systems. More specifically, the invention relates to a generalized system and method for formally describing business processes in a manner that allows computer systems to control the execution of the business processes directly from their description, and provides different versions of business processes for different sets of users.

### DESCRIPTION OF RELATED ART

In most current e-commerce systems, the steps of a business process, or the action a system takes in response to a user action in such a process, are not made explicit, but are buried in software code for the dynamic pages and for the application server. This makes the modification of computer implemented business processes extremely difficult and fragile. For example, to makes changes in the order that steps are taken requires essentially rewriting the software code for the application and the pages for the user interface. For commerce systems made to be used by different companies, this presents a big problem as most companies' business processes differ from those of other companies to a small or large extent. Thus, deploying such commerce systems at each different company incurs large overhead in terms of time and money required to rewrite the business processes.

One class of commercial processes is referred to as “workflow.” Workflow systems are designed to describe processes where a set of documents go through a number of processing steps. For example, insurance claims are first filed by a field agent. Then they are placed in the in-basket of a claim adjuster. The claim adjuster goes through claims one by one in his in-basket. Once he processes a claim he sends them to the in-basket of the reimbursement handler. Here the nature of the business process is the old manual process of shuffling documents from one department to another. There are a number of commercial workflow systems. Some of them use e-mail or Web based interfaces. The “in-box” corresponds to a worklist. The processing stages may be actual people or sometimes software systems, such as a credit check system. The workflow is captured in “scripts” or programs and they are thus less easy to modify than state machines, but as they are higher level programs, it is easier to modify workflow scripts than all the software code for a business process.

The pattern of user interaction with e-commerce business processes is very different from that of traditional workflow systems. In Internet based e-commerce systems, a user takes an action, such as clicking a submit button on a web page. This results in the form data on that page being sent to the system, the system acting on it and presenting another page to the user. For example, a user can go to a shopping web site, first fill out the login page and press OK. This results in her user name and password being sent to the system, which then checks if the person is a legal user and if so shows her the catalog page. Then the system waits until the user makes a selection to fill the shopping basket. This pattern of system action based on a user action and then waiting for the user to initiate the next step is not well modeled by existing workflow systems and they are therefore typically not used for modeling business processes in e-commerce systems. Also, traditional workflows systems are typically expensive, large software systems requiring expensive support.

It is clear, therefore, that a need exists for a flexible technique for modeling business processes using a state-machine approach.

### SUMMARY OF INVENTION

In accordance with the invention, a method for allowing flexible creation and alteration of business processes within a commerce system includes using state machines to describe the actions that can be taken by particular roles at particular points in a process. The state machines are used by a commerce system to enforce validity of user actions, to track the execution of actions within an instance of the business process, to provide the user interface with a list of actions available to a user working on an instance of the business process, to provide coordination between state machines, and to allow different organizations to have varied business processes.

In typical commerce systems, state information and enforcement of action validity are embedded within the implementation of each of the business processes. Making changes to the business processes is a time consuming endeavor which must be undertaken by system implementers. By modeling and executing business processes as state machines, these processes can be modified without making any changes to the underlying computer programs that are implementations of the business processes. A commerce function is reconfigured simply by reconfiguring its corresponding state machine. In addition to the functionality of traditional state machines, the present invention adds three key features: the concept of roles, the coordination of interactions of multiple parties, and the ability to allow different organizations to use different versions of the business process.

By allowing the availability of actions at a particular state to be limited to particular roles, designers of the business processes are free from having to put each role in its own state machine and having to deal with the potentially many intricate dependencies between the state machines.

By allowing an instance of one state machine to trigger an action in one or more instances of the same or different state machines, coordinating interaction of multiple parties is enabled. For example, it may be desired that the closing of an auction by a seller in an auction business process disable the ability of buyers to increase their bids in the bidding business process.

By choosing the version of the business process to be used based on the organization, a marketplace has flexibility to allow large companies to go thorough processes with many steps and small companies to go through simpler processes. For example, a large company may want to have one or more approvals on every order it places while a one person company would probably not want any. The version of the business process chosen can be based on any number of factors, not just organization.

In accordance with the foregoing features and objectives, the invention provides a system and method for representing a business process within a computing system, comprising the steps of defining the business process using a state-machine based representation where transitions of the state machine represent roles and actions, and states of the state machine represent stages in the business process where the commerce system is waiting for an event to occur; and identifying the actions that participants with particular roles can perform at particular stages of the business process by corresponding state in the state machine and out-going transitions from that state.

The invention further provides a system and method for executing a business process represented as a state machine running on a computing system, where transitions of the state machine represent roles of participants in the business process and actions that can be taken as part of the business process, and states of the state machine represent stages in the business process where the business process is waiting for an event to occur, the method comprising receiving from a user a command representing a desired action to be performed as part of the business process; checking the role of the user within the business process and a context in which the command occurs; and if the command is allowable by a user with the role within the context, executing the command.

### BRIEF DESCRIPTION OF DRAWINGS

The invention will be described in detail in the following description of preferred embodiments with reference to the following figures wherein:

FIG. 1 depicts a pictorial representation of a distributed data processing system in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a schematic diagram showing an illustrative flow of how a business process represented as a state machine can be loaded into a commerce system to control the actions available to a user based on the user's role and state within the business process;

FIG. 5 is a schematic diagram showing the operation of a commerce system that uses instances of state machines to track and control a user's state within the business process;

FIG. 6 is a schematic diagram showing simple changes that can be made to the state machines to change or create new business processes;

FIG. 7 is a schematic diagram showing an illustrative flow of a commerce system's instance of a state machine reaching a new state and triggering actions in other instances of another state machine;

FIG. 8 is a block/flow diagram showing a system/method for handling a commerce function invocation by the commerce flow engine; and

FIG. 9 is a block/flow diagram showing a system/method for handling messages that trigger commerce actions in one or more instances of one or more state machines.

### DETAILED DESCRIPTION OF PREFERRED EMBODIMENTS

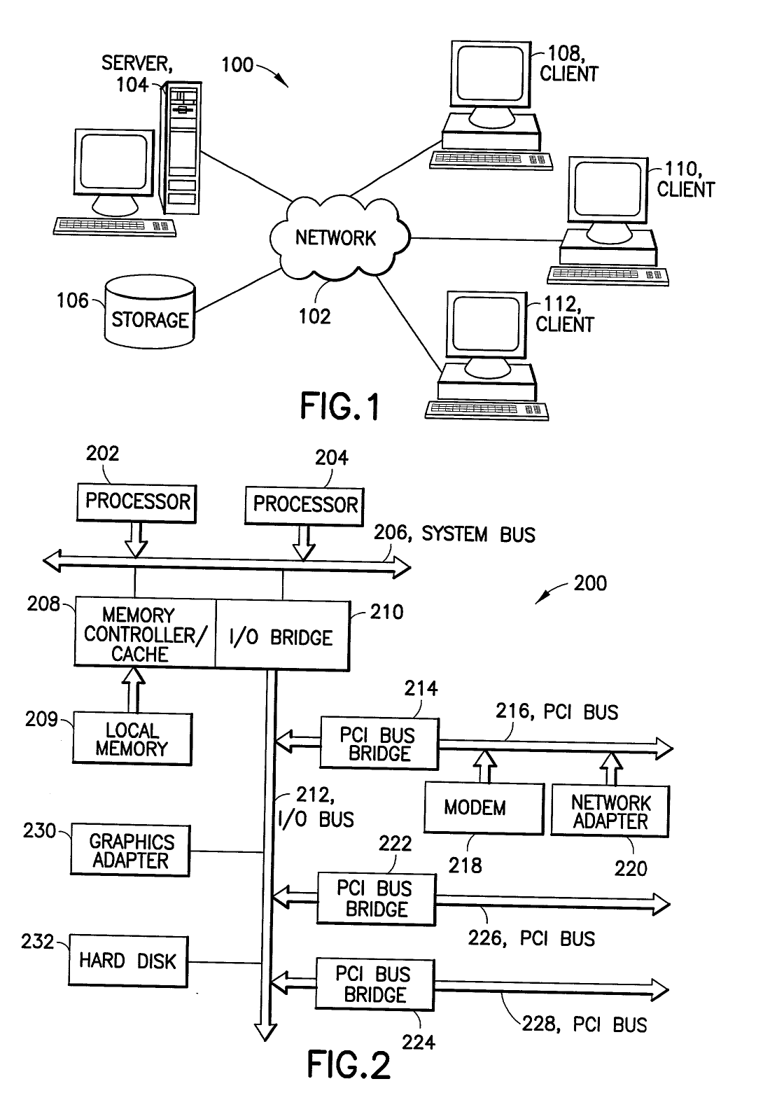

FIG. 1 depicts a pictorial representation of a distributed data processing system in which the present invention may be implemented. Distributed data processing system 100 is a network of computers in which the present invention may be implemented. Distributed data processing system 100 contains a network 102, which is the medium used to provide communications links between various devices and computers connected together within distributed data processing system 100. Network 102 may include permanent connections, such as wire or fiber optic cables, or temporary connections made through telephone connections.

In the depicted example, a server 104 is connected to network 102 along with storage unit 106. In addition, clients 108, 110, and 112 also are connected to network 102. These clients 108, 110, and 112 may be, for example, personal computers or network computers. For purposes of this application, a network computer is any computer, coupled to a network, which receives a program or other application from another computer coupled to the network. In the depicted example, server 104 provides data, such as boot files, operating system images, and applications to clients 108-112. Clients 108, 110, and 112 are clients to server 104. In these particular examples, server 104 may host an on-line store or business to sell goods and services to customers. In these examples, server 104 hosts an integrated market hub in accordance with a preferred embodiment of the present invention. Customers or buyers at clients 108, 110, and 112 may view goods and services offered by a business or supplier and purchase these goods and services on-line as an example of a business process in accordance with the invention.

Distributed data processing system 100 may include additional servers, clients, and other devices not shown. In the depicted example, distributed data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. In this type of network, hypertext mark-up language (HTML) documents and applets are used to exchange information and facilitate commercial transactions. Hypertext transfer protocol (HTTP) is the protocol used in these examples to send data between different data processing systems. Of course, distributed data processing system 100 also may be implemented as a number of different types of networks such as, for example, an intranet, a local area network (LAN), or a wide area network (WAN). FIG. 1 is intended as an example, and not as an architectural limitation for the present invention.

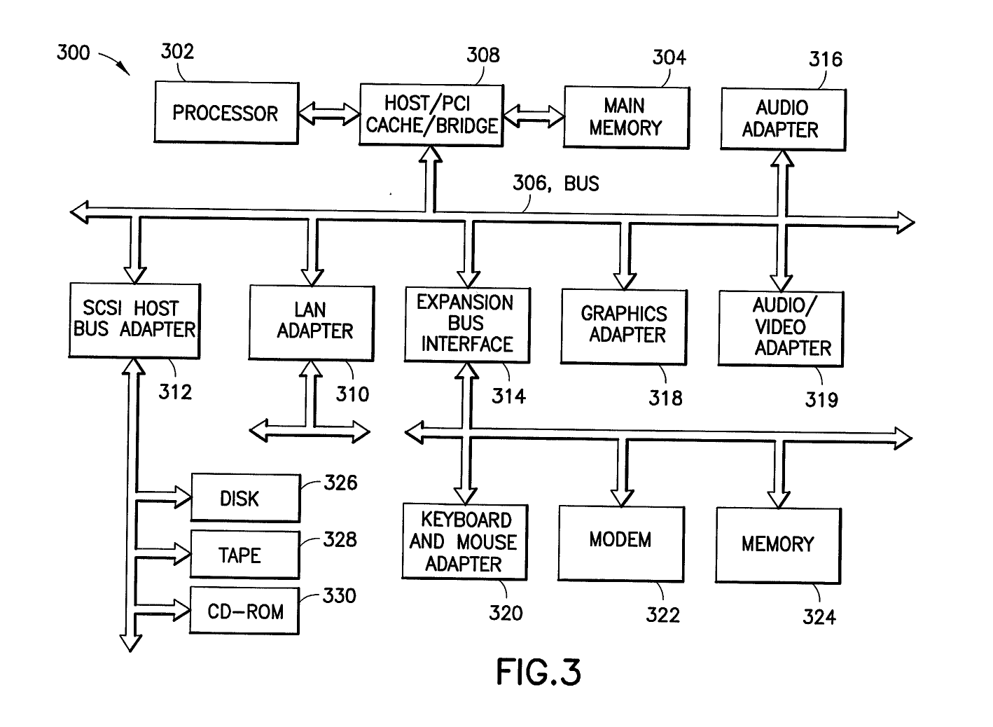

Referring to FIG. 2, a block diagram of a data processing system that may be implemented as a server, such as server 104 in FIG. 1, is depicted in accordance with a preferred embodiment of the present invention. Server 200 may be used to host a site for a business selling goods and/or services, or execution of any other business process in accordance with the invention.

Server 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, server 200 allows connections to multiple network computers. A graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

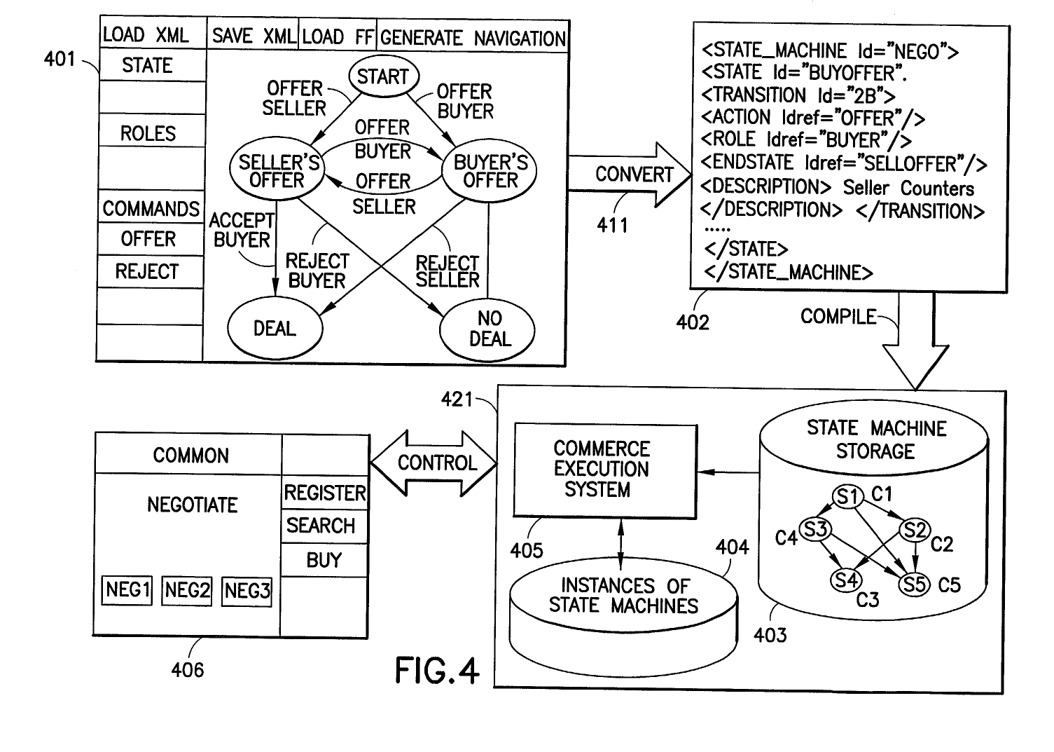

With reference now to FIG. 3, a block diagram illustrating a data processing system in which the present invention may be implemented is depicted in accordance with a preferred embodiment of the present invention. Data processing system 300 is an example of a client computer on which a customer or buyer may interact with a server running a business process represented as a state machine, the business process being, for instance, an auction or other mechanism for buying or selling goods or services. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards.

In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object-oriented programming system such as Java may run in conjunction with the operating system and provides calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

Data processing system 300 may take various forms, such as a stand alone computer or a networked computer. As a further example, data processing system 300 may be a personal digital assistant (PDA) device, which is configured with ROM and/or flash ROM in order to provide non-volatile memory for storing operating system files and/or user-generated data. The depicted example in FIG. 3 and above-described examples are not meant to imply architectural limitations. For example, data processing system 300 also may be a notebook computer or hand-held computer in addition to taking the form of a PDA. Data processing system 300 also may be a kiosk or a Web appliance.

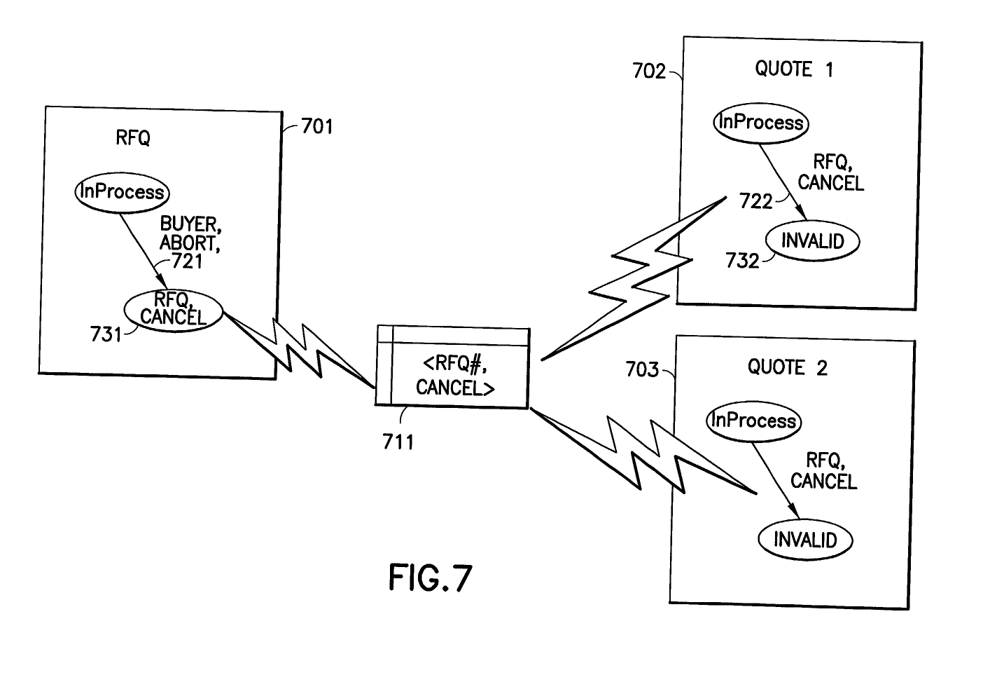

The present invention is related to electronic commerce and flexibility in automated commerce business processes. In a particularly useful embodiment of the present invention, commerce business processes are represented as state machines (such as 601 in FIG. 6) in commerce systems such as electronic marketplaces, procurement and other buyer systems, storefronts and other seller systems. The state machines may, for instance, be implemented within the environment of FIGS. 1-3. Each finite state machine has a set of states (such as 631 and 632 in FIG. 6) and a set of transitions (such as 621 in FIG. 6) between the states. States are symbolic representations of the state of a business object such as a Request For Quote (RFQ) or a Quote for an RFQ. Transitions are a tuple of <command, role>. For instance in FIG. 6, 623 is a transition where the command is “offer” and the role is “buyer.” This means that the buyer makes an offer from the “Buyer's Offer” state (634). Command corresponds to an action, or a unit of work, that is carried out by the commerce system and are the building blocks of the business process. Role corresponds to the role within the process of the party issuing the command, such as requisitioner, buyer, seller, administrator, system, etc.

The state machine in accordance with the invention provides three basic functions:

1. Before a command is executed, the state machine checks whether it is valid to execute the command given the current state of the business process.

2. After a command is executed, the state machine supplies a list of commands which can be executed next. This list can be returned as a set of options (for example, as a web page) to the user with the appropriate button/links to the valid commands.

3. The state machine provides a formal mechanism for specifying and executing complex (including interrelated) business processes.

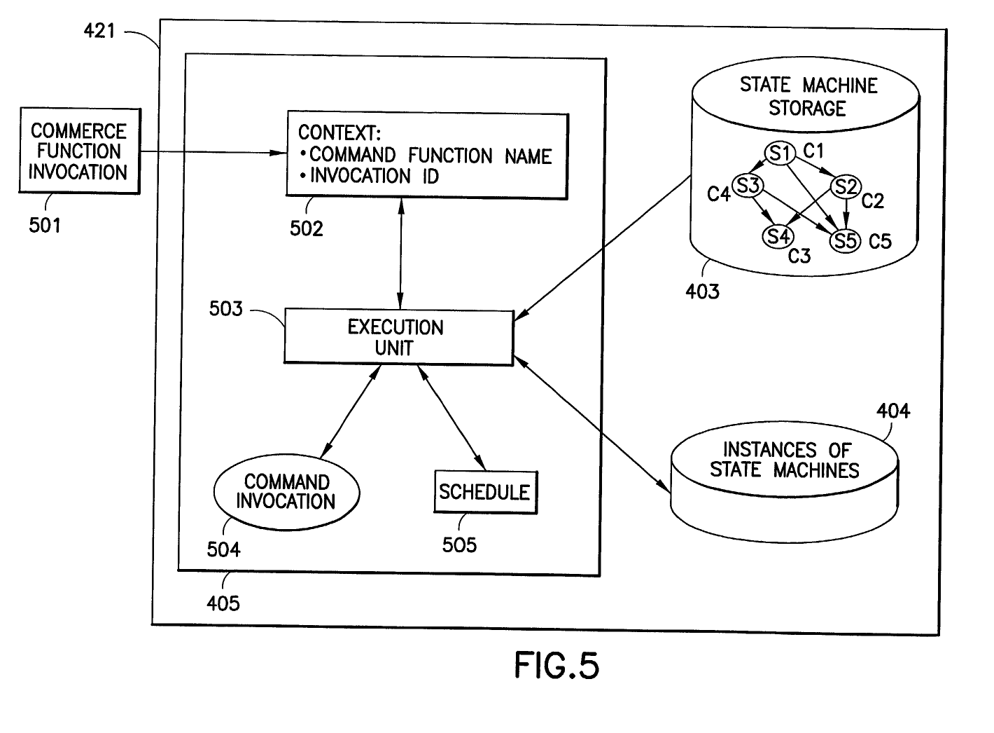

FIG. 4 shows a functional block diagram of a system for creating a business process in accordance with the present invention. The primary functional components are an interface 401, an XML representation 402 of a state machine representing the business process to be implemented, a commerce flow engine 421, and a client 406.

Business processes can be created and modified in accordance with the invention by changing, adding, and/or removing states and transitions from the state machine representation of the business processes using tools such as a graphical user interface (GUI) 401. GUI 401 can be used to view and edit a graphical representation of a state machine representing a business process. Once the process designer has modified the graphical representation, the system converts 411 the newly depicted state machine into an XML representation 402. This conversion is done by software. The software goes through the graphical tool and reads the name of each state, the transitions that go out from it and the states those transitions end in. It then writes this information out using an XML schema. In one alternative embodiment of the invention, a process designer editor can create an XML representation 402 of the process directly using standard editing tools. In another embodiment, the state machine creation tool represented as GUTI 401 can be implemented to directly enter the state machine representation into commerce flow engine 421. Again, this conversion is done by software. The software goes through the graphical tool and reads the name of each state, the transitions that go out from it and the states those transitions end in. It then writes out in the form of SQL statements that can directly populate a database table for the flow engine a tabular description of the state machine. Tabular descriptions of state machines are well known in the art. The commerce flow uses its state machine table to control the business process. It is the function of commerce flow engine 421 to store and execute the state machine representation of the process thus created, including management of process user inputs. When the process designer compiles the newly created or modified process, the resulting state machine is loaded for storage in state machine storage 403. When a user works on a business process, a state machine is retrieved from 403. The particular state machine retrieved from storage 403 depends on the business process, and may depend upon the identity of the client 406, or other variable criteria. Table 404 stores the current state of a particular instance of the process. For example, in an auctions site, a number of auctions may be going on. Suppose each auction follows the same business process. Then the process for all the auctions are described by the same state machine in 403. However, some of the auctions may be in the draft state, some may be in the active state and some may be in the closed state. Thus the state of each instance of a business process needs to be tracked. This current state of an instance of a state machine is stored in 404.

End users may interact with the system, for instance by means of a web browser operating on client 406. Actions requested by end users are passed to the commerce flow engine 421, and more particularly to the commerce execution system 405. The commerce execution system processes client inputs depending on the process state machine in 403, the current state of the process instance in 404 and the role of the action requester. The commerce execution system 405 also provides output to the client, for instance in response to a query by the client 406 to retrieve the list of actions that are valid for a given role at the current state 404 of the business process and the description of the business process stored in 403. This list can be returned and presented to the requester at the client 406. The functional and storage aspects of the commerce flow engine may be performed by a single or multiple servers and storage devices such as 104 and 106 in FIG. 1.

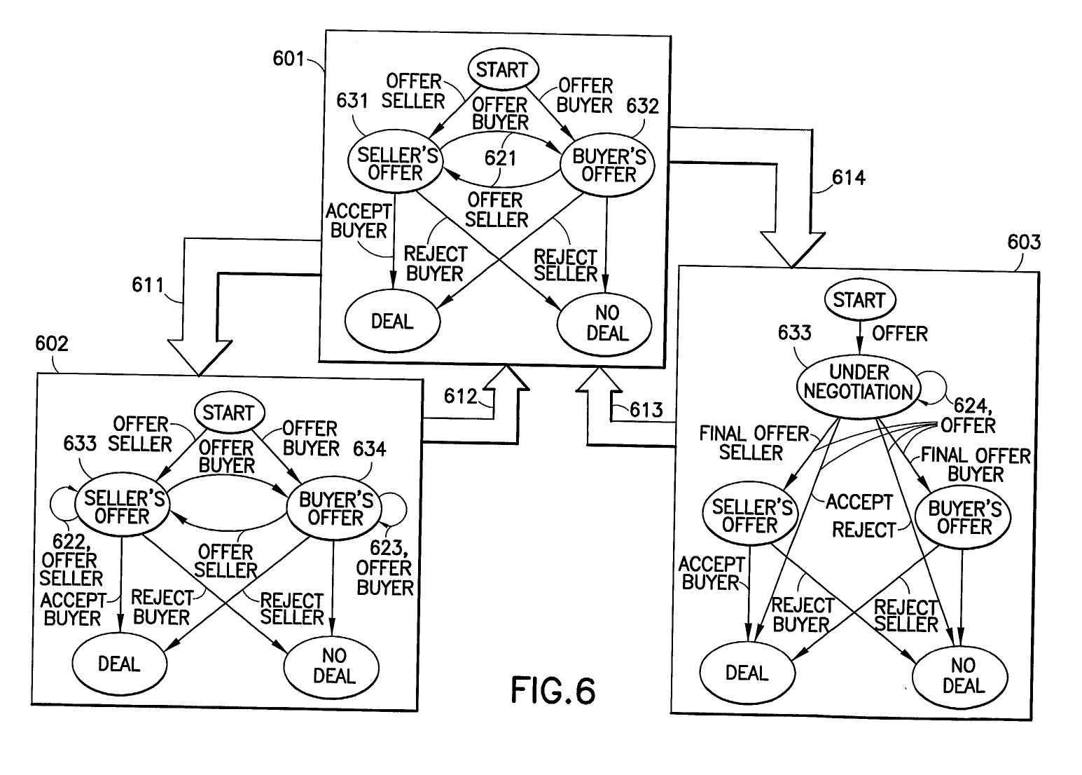

FIG. 5 describes in further detail the operation of the commerce flow engine 421. Commerce flow engine 421 includes state machine storage 403, the current state of instances of state machines 404, and a detailed view of the commerce execution system 405.

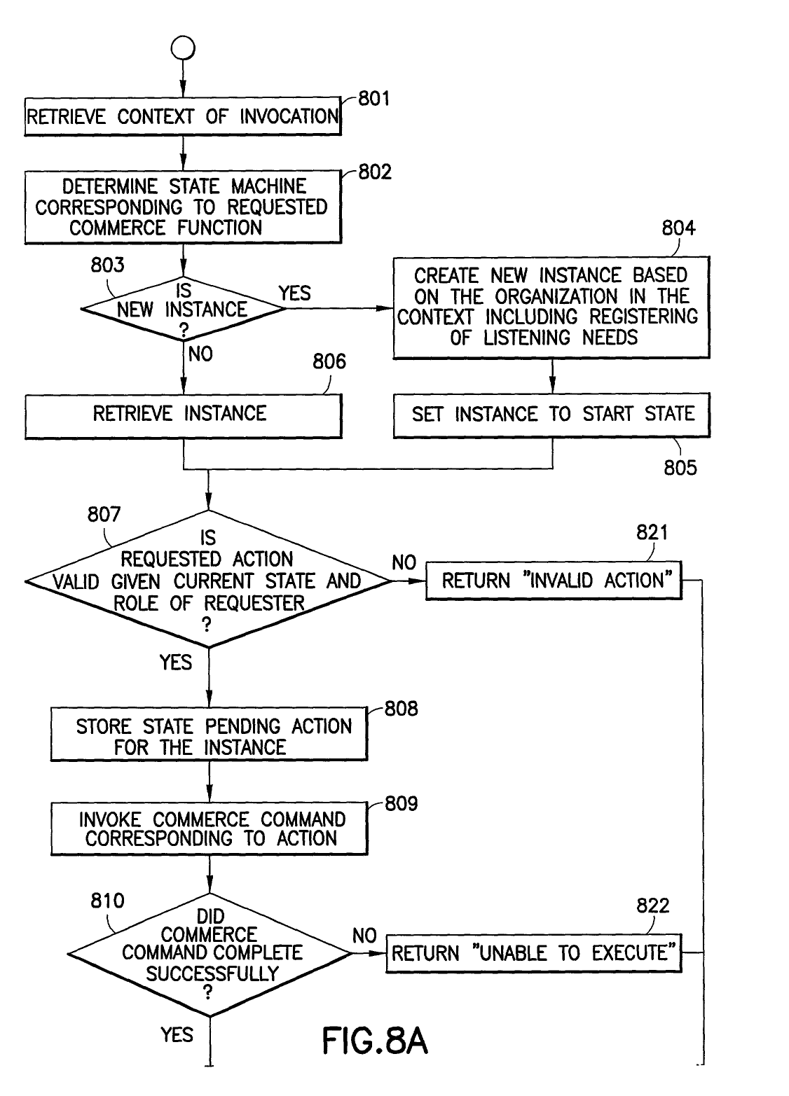

Commerce execution system 405 includes an execution unit 503 for executing the business processes depicted in state machine format in response to commands from an end user. Commands from an end user reach the execution unit 503 by one of three means: from a commerce function invocation 501 requested by a user or some other external party from a client 406; from one command 504 invoking another command (as shown in FIG. 7); and from a scheduler 505 which invokes commands at given times. For example, an auction process may be closed manually or be set to close after 1 hour. In the second case, the scheduler will generate a close-auction event which will make the system close the auction. When a commerce function is invoked by a user 501, the context 502 within which the command was invoked needs to be derived. The context consists of (a) the session information which includes information about the user and her roles and permissions, and (b) the data submitted by the user such as form entries and the data stored in the form such as the identification of the process and the identification of the business object. For example, if a user is submitting a bid for an auction, the context would contain the username, roles, the amount of the bid, and the identification number of the auction the bid is made on. This context is used by the execution unit 503 to the determine validity of requested actions based on the context 502 including the requested action and role of the requester, the current state of the instance being acted on (stored in 404), and the business process itself (stored as a state machine in 403).

FIG. 6 shows examples of alterations that can be made to a business process represented as state machines in order to create a new version thereof. This alteration may be performed using the mechanism described in 401, 402 in FIG. 4. Multiple, varied state machines, such as 601, 602 and 603, can exist for a given business process. Each of these different versions of the business process (601, 602 and 603) share a large number of actions that are implemented as software in the commerce system. Thus the different state machines (601, 602, 603) allow us to run three different versions of a business process but with only one version of the corresponding software components. There are four basic types of alterations that can be made to an existing business process: adding one or more transitions 611; removing one or more transitions 612; adding one or more states and their transitions 614; and removing one or more states and their transitions 613.

An example of adding 611 transitions can be seen in the alteration of machine 601 to machine 602. Machine 601 shows a two-party negotiation in which buyers and sellers alternately make offers to one another until one of the two parties either outright accepts or rejects the other party's previous offer. By adding transitions in 601 to create 602, the business process can now allow the seller or buyer to modify their own offers (transitions 622 and 623). Transition 623 from state 634 also returns to state 634 with the buyer modifying its previous offer. The analogous offer modification is now allowed for the seller with transition 622 going to and from state 633.

An example of removing 612 transitions can be seen in the alteration of machine 602 to machine 601. In this example, the ability of a buyer and seller to change their own offer in machine 602 is removed to create machine 601. Specifically, transitions 622 and 623 are removed from machine 602 to create machine 601.

An example of adding 614 a state and its transitions can be seen in the alteration of machine 601 to machine 603. A new state 635 has been added to create machine 603. The transitions labeled 621 in machine 601 have been replaced by those labeled 624 in machine 603. The new machine 603 now allows for either the buyer or seller to make a final offer. A counteroffer cannot be created for a final offer. The other party must either accept or reject this final offer.

An example of removing 613 a state and its transitions can be seen in the alteration of machine 603 to machine 601. One state 635 is removed. Its transitions 624 are replaced by transitions 621 on other states in machine 601. The new machine 601 no longer allows for final offers as were previously allowed by machine 603.

The modifications described above can be made by the process designer using GUI tool 401, XML editor 402, or any other editing means.

Often, related business processes need to be synchronized. For example, in a request for quotes (RFQ) process, a buyer drafts and sends out a RFQ. A number of sellers in turn bid on the RFQ. Since the bid process itself is involved (the bid may be in draft state, or awaiting approval or being modified and resubmitted, etc.), it is simpler to consider the buyer's process and the seller's process as different business processes. This allows us to handle cases where one seller requires approvals before he submits bids, while the other does not. However, these different business processes need to be coordinated. For example, a bid can not be submitted before the RFQ is sent out. Also, once the RFQ is closed, the sellers are not allowed to modify and resubmit bids. FIG. 7 shows how such coordination between different business processes is accomplished.

FIG. 7 shows the interaction of one machine instance 701 with two other machine instances 702 and 703. The coordination of the state machine instances is handled by a message 711 sent from a source 701 to any targets listening 702 and 703 to that source. When state machine instances such as 702 and 703 are created (and stored in storage 404), they are registered to listen to any other instances (such as 701, also stored in 404) for which they need to know the status. For example, when a quote for an RFQ is created, it is known for which RFQ it is being quoted. The quote needs to listen to the RFQ, watching for new messages. For example, if an RFQ is canceled, its corresponding quotes need to be marked invalid. To accomplish this, in FIG. 7, a buyer performs an abort action 721 on its RFQ 701 which puts the RFQ in a new state, canceled 731. At this point a message 711 is sent out from the RFQ 701 and is picked up by any listening quotes 702 and 703. The incoming message is treated as a new action. For quote 702, the action 722 is executed, the canceling of the RFQ. This action puts the quote in a new state, invalid 732. Similar processing takes place for other quotes such as 703 listening to the RFQ 701.

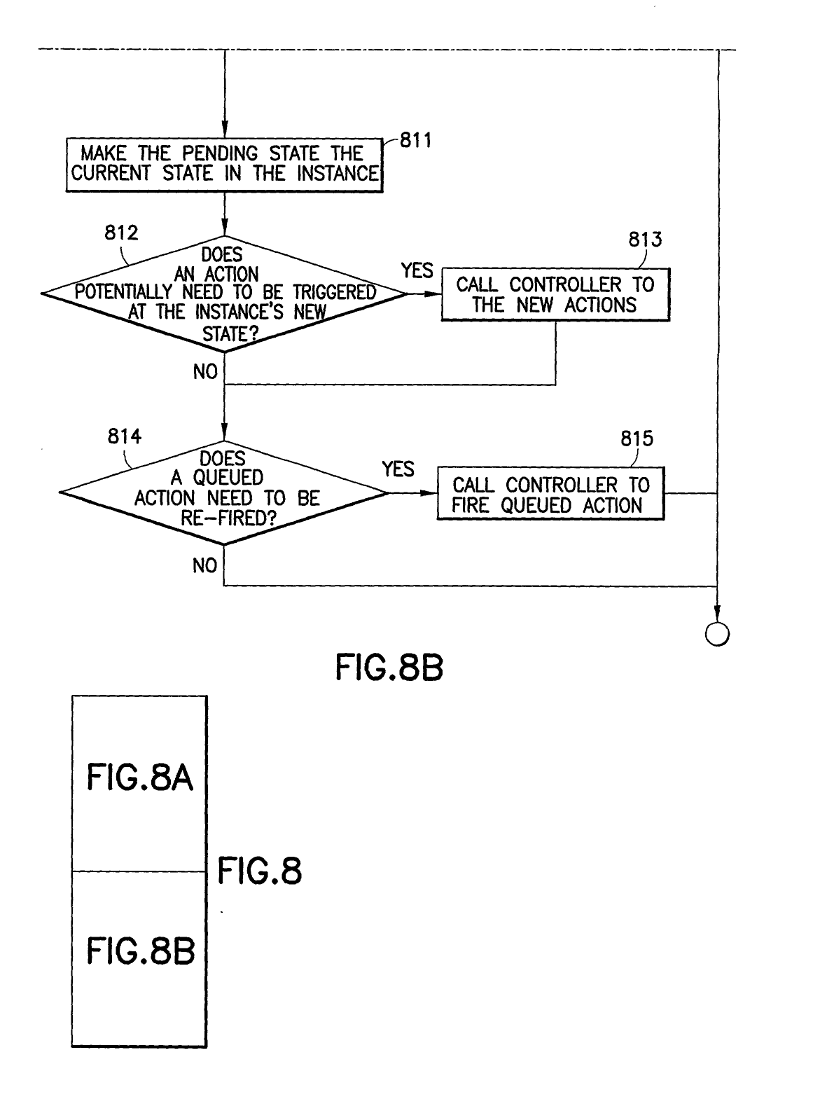

FIG. 8 shows how an incoming commerce action is handled by the commerce flow engine 421. First, the context (502) of the invocation of the action is retrieved 801 including retrieval and marshaling of incoming parameters and deriving of user and role information.

Next, the commerce flow engine determines 802 which state machine corresponds to the requested commerce function. This is known from the action and its context.

Next, the commerce flow engine determines 803 whether this action is creating a new instance 804 or working on an existing one 806. Part of the creation 804 of the instance is to register for those other instances from which it needs to know outgoing messages. This need for registering has been described previously in connection with FIG. 7. The state machine from which the instance is created in step 804 can vary based on the user's organization. This allows different organizations to use different state machines enabling them to vary their business processes to those that other organizations use. Once this new instance is created, it is set 805 to the start state used by its underlying state machine.

After creating or retrieving the instance, the commerce flow engine will determine 807 whether the action is valid. An action is valid if for the role of the requester there is a transition in the state machine from the instance's current state with the requested action. If the action is not valid for the role based on the instance's state, the commerce flow engine returns 821 an error that the action is invalid.

After validating the requested action, the commerce flow engine looks at the state machine in 403 to determine the state to which the transition corresponding to the action would move the instance in 404, and stores 808 this state as a pending state.

Next, the commerce execution system 405 is invoked 809 to execute the command that corresponds to the requested action. If this command does not complete successfully 810, the commerce flow engine 421 returns 822 the command's error.

After the command has been successfully executed, the pending state that had been stored in step 808 is now stored 811 as the current state with the pending state being cleared.

Next, the commerce flow engine looks at the state machine to determine 812 whether a message needs to be sent out when the current state is reached within the machine. These are the messages described in FIG. 7. If a message needs to be sent 813, it is sent to a process which controls the execution (or “firing”) of actions based on the incoming messages.

Finally, while all the above processing was taking place, the controller may have tried to fire an action for this instance. If so, the controller will have seen that the instance was already being worked on and stored the action to be fired upon completion. The commerce flow engine looks 812 for these stored actions. If one or more of these actions are queued, the controller is called 815 to re-fire the action.

The above description describes actions being fired from messages. These fired actions are described as asynchronous with a priority not higher than other actions. Other embodiments of the invention could allow for synchronous actions where the instance sending out the message waits for successful completion by a specific subset of those instances that are listening.

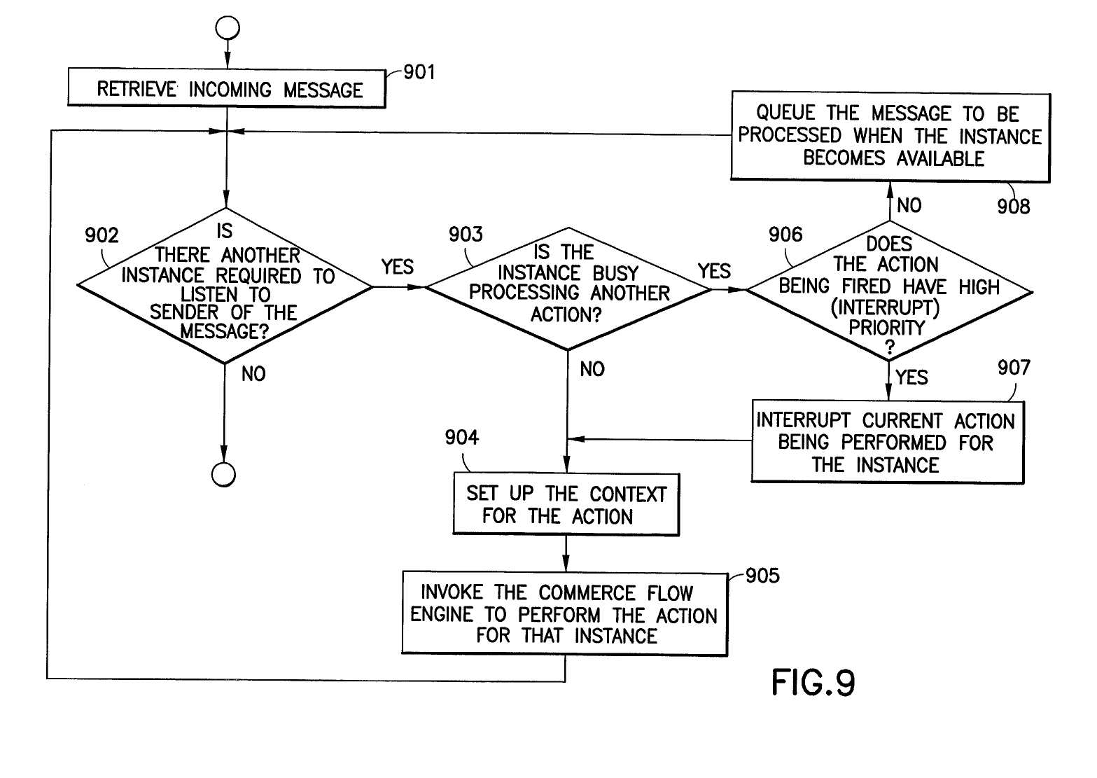

FIG. 9 shows how a message can be handled by a controller which will trigger actions in the state machine instances that are registered as listeners to the sender of the message. The controller is a function of the execution unit 503. First, the incoming message is retrieved 901 by the controller. Next, the controller checks 902 if there is an instance needing an action triggered for this message. Instances register to listen to senders upon there creation.

If there is an instance needing to perform an action based on the incoming message, the controller checks 903 if another action is currently being processed for this instance. If not, the controller sets up the context 904 for the action and invokes 905 the commerce flow engine to perform the action.

If another action is currently being processed for the instance, the controller then checks 906 whether the action has a high priority indicating that an interrupt should be performed. If so, the action currently being executed for this in the commerce flow engine is interrupted 907. Then, the controller sets up the context 904 for the action and invokes 905 the commerce flow engine to perform the action.

If another action is currently being processed for the instance and the action needing to be processed does not have a high priority, the message is queued 908 for this instance. As described in the explanation of FIG. 8, the instance will check 812 for stored messages that need to be processed.

It is important to note that while the present invention has been described in the context of a fully functioning data processing system, those of ordinary skill in the art will appreciate that the processes of the present invention are capable of being distributed in a form of a computer readable medium of instructions and a variety of forms, and that the present invention applies equally regardless of the particular type of signal bearing media actually used to carry out the distribution. Examples of computer readable media include recordable-type media such as a floppy disc, a hard disk drive, a RAM, and CD-ROMs and transmission-type media such as digital and analog communications links.

The description of the present invention has been presented for purposes of illustration and description, but is not limited to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for representing a business process within a computing system, comprising the steps of:
defining the business process using a state-machine based representation where transitions of the state machine represent roles and actions, and states of the state machine represent stages in the business process where the commerce system is waiting for an event to occur;
identifying the actions that participants with particular roles can perform at particular stages of the business process by corresponding state in the state machine and out-going transitions from that state.

2. The method of claim 1, further comprising altering the business process by changing its state-machine based representation.

3. The method of claim 1, wherein attributes of a state-machine based representation are tailored to a particular user.

4. The method of claim 1, wherein the state-machine based representation includes means for validating that actions taken by a user are allowed by the state machine description so as to ensure that the user has a role that can perform the requested action at that state.

5. The method of claim 1, wherein the business processes and their state-machine based representations can be synchronized with other business processes by passing messages between state machines.

6. A method for executing a business process represented as a state machine running on a computing system, where transitions of the state machine represent roles of participants in the business process and actions that can be taken as part of the business process, and states of the state machine represent stages in the business process where the business process is waiting for an event to occur, the method comprising:
receiving from a user a command representing a desired action to be performed as part of the business process;
checking the role of the user within the business process and a context in which the command occurs;
if the command is allowable by a user with the role within the context, executing the command.

7. The method of claim 6, further comprising the step of displaying to users a list of possible commands to be issued by the user as part of the business process.

8. The method of claim 7, where the displayed commands are selected for display based on the user's role within the business process, the context of the business process, and the state of the business process.

9. The method of claim 6, wherein different versions of a business process represented as different state machines share software for actions common in the different state machines, and share user interfaces by generating a means of user interaction based on the state machine descriptions.

10. The method of claim 6, where the execution of different instances of a particular business process are handled by storing a current state for each instance of the business process

11. A system for executing a business process represented as a state machine running on a computing system, where transitions of the state machine represent roles of participants in the business process and actions that can be taken as part of the business process, and states of the state machine represent stages in the business process where the business process is waiting for an event to occur, the system comprising:
means for receiving from a user a command representing a desired action to be performed as part of the business process;
means for checking the role of the user within the business process and a context in which the command occurs;
means for, if the command is allowable by a user with the role within the context, executing the command.

12. A computer program product in a computer readable medium for representing a business process within a computing system, the computer program product comprising:
first instructions for defining the business process using a state-machine based representation where transitions of the state machine represent roles and actions, and states of the state machine represent stages in the business process where the commerce system is waiting for an event to occur;
second instructions for identifying the actions that participants with particular roles can perform at particular stages of the business process by corresponding state in the state machine and out-going transitions from that state.

13. A computer program product in a computer readable medium for executing a business process within a computing system, the computer program product comprising:
first instructions for receiving from a user a command representing a desired action to be performed as part of the business process;
second instructions for checking the role of the user within the business process and a context in which the command occurs;
third instructions for, if the command is allowable by a user with the role within the context, executing the command.
